(19) United States
(12) Patent Application Publication
(10) Pub. No.: US 2012/0094118 A1
(43) Pub. Date: Apr. 19, 2012

(54) INFRARED LIGHT REFLECTOR, INFRARED LIGHT REFLECTING LAMINATED GLASS, AND LAMINATED GLASS AND LAMINATE HAVE CHOLESTERIC LIQUID CRYSTAL LAYERS

(75) Inventors: Kazuhiro Oki, Kanagawa (JP); Mitsuyoshi Ichihashi, Kanagawa (JP); Hitoshi Yamada, Kanagawa (JP)

(73) Assignee: FUJIFILM CORPORATION, Tokyo (JP)

(21) Appl. No.: 13/377,361

(22) PCT Filed: Jun. 10, 2010
(86) PCT No.: PCT/JP2010/059831

§ 371 Date: Dec. 9, 2011

(30) Foreign Application Priority Data
Jun. 11, 2009 (JP) 2009-140162

(51) Int. Cl. G02B 5/20; C09J 7/02; B32B 7/12

(52) U.S. Cl. 428/354; 359/359

(57) ABSTRACT

To provide an infrared-light reflective plate having improved selective reflectivity characteristics, there is provided an infrared-light reflective plate reflects an infrared-light of equal to or longer than 700 nm including a substrate, and, on at least one of surfaces of the substrate, at least four light-reflective layers, X1, X2, X3 and X4, formed of a fixed cholesteric liquid crystal phase, and disposed in this order from the substrate, wherein the reflection center wavelengths of the light-reflective layers X1 and X2 are same with each other and are λ₁ (nm), and the two layers reflect circularly-polarized light in opposite directions; the reflection center wavelengths of the light-reflective layers X3 and X4 are same with each other and are λ₂ (nm), and the two layers reflect circularly-polarized light in opposite directions; and λ₁<λ₂ is satisfied.

### TECHNICAL FIELD

The present invention relates to an infrared-light reflective plate with plural light reflective layers formed of a fixed cholesteric liquid crystal phase, mainly for use for heat shield for windows of building structures, vehicles, etc, and relates also to an infrared-light reflective laminated glass using it. The present invention relates also to a laminate having a cholesteric liquid crystal layer, and a laminated glass having it.

### BACKGROUND ART

With the recent increase in interest in environment and energy-related issues, the needs for energy-saving industrial products are increasing; and as one of them, glass and film are desired that are effective for heat shield for windowpanes for houses, automobiles, etc., or that is, effective for reducing heat load due to sunlight. For reducing heat load due to sunlight, it is necessary to prevent transmission of sunlight rays falling within any of the visible range or the infrared range of the sunlight spectrum.

Laminated glass coated with a special metallic film capable of blocking out thermal radiations, which is referred to as Low-E pair glass, is often used as eco-glass having high heat-insulating/heat-shielding capability. The special metallic film may be formed by lamination of plural layers, for example, according to a vacuum-deposition method disclosed in Patent Reference 1. The special metallic film formed through vacuum deposition is extremely excellent in reflectivity, but the vacuum process is nonproductive and its production cost is high. In addition, when the metallic film is used, it also blocks electromagnetic waves; and therefore in use in mobile telephones and the like, the metallic film may causes radio disturbance; or when used in automobiles, there may occur a problem in that ETC (electronic toll collection) could not be used.

Patent Reference 2 proposes a heat-reflecting transparent substrate having a metallic fine particles-containing layer. The metallic fine particles-containing film is excellent in visible light transmittance but has a low reflectivity to light falling within a wavelength range of from 700 to 1200 nm that significantly participates in heat shielding, and therefore has a problem in that its heat-shielding capability could not be enhanced.

And Patent Reference 3 discloses a heat-shielding sheet that has an infrared-absorbing dye-containing layer. Use of an infrared-absorbing dye may lower sunlight transmittance but is problematic in that the film surface temperature rises through sunlight absorption and the heat-shielding capability of the film lowers through re-release of the heat.

And Patent Reference 4 discloses a laminated optical film having a retardation film with predetermined characteristics and a reflective circularly-polarizing plate and having infrared reflectivity, and this discloses an example of using a cholesteric liquid-crystal phase as the retardation film.

And Patent Reference 5 discloses an infrared-light reflecting article comprising a visible light transparent substrate and an infrared-light reflecting cholesteric liquid-crystal layer disposed on the substrate.

And Patent Reference 6 discloses a polarizing element having plural cholesteric liquid-crystal layers; however, the laminate formed through lamination of cholesteric liquid-crystal layers is used mainly for efficiently reflecting visible-range light.

And Patent Reference 7 discloses a circularly-polarized-light-extracting optical element formed through lamination of plural liquid-crystal layers in which the liquid-crystal molecules have substantially the same helical axis direction and have the same helical-rotation direction.

In fact, it is difficult to completely reflect a light having a specific wavelength by using a light-reflective film having a light-reflective layer formed of fixed cholesteric liquid-crystal; and in general, a specific retarder, a λ/2 plate, is used. For example, in Patent References 4 and 5, a light-reflective layer formed of fixed cholesteric liquid-crystal phase is formed on both sides of a λ/2 plate and tried for reflection of a right circularly-polarized light and a left circularly-polarized light having a predetermined wavelength, in which the two light-reflective layers have the same helical-rotation direction and have the same helical pitch.

However, as described above, a λ/2 plate is a special retarder, and its production is difficult and its production cost is high. In addition, the material for the plate is limited to a special one, and the use of the plate may be thereby limited. Further, in general, a λ/2 plate could act as a λ/2 plate to the light coming in the plate surface in the normal direction thereto; however, strictly, it could not function as a λ/2 plate to the light coming therein in oblique directions. Accordingly, the constitution containing a combination of λ/2 plates involves a problem in that it could not completely reflect the light coming therein in oblique directions.

On the other hand, heretofore, various types of laminated glass produced by sticking at least two sheets of glass with an interlayer film put therebetween so that, when it is broken, the glass pieces may not scatter everywhere, have been proposed for automobile parts, etc. As the material of the interlayer film, used is polyvinyl butyral. Before its practical use, the laminated glass having the constitution as above is previously tested in a light-proofness test, in which the glass is exposed to ultraviolet light for a long period of time and checked for degradation.

Regarding the cholesteric liquid-crystal phase, not only use thereof as a light-reflective layer but also use thereof as various types of functional layers such as a layer that changes its light depending on the electric field applied thereto or the like has been proposed; and incorporating a cholesteric liquid-crystal layer into laminated glass has been tried (for example, Example 1 in Patent Reference 8). However, when the laminated glass having a cholesteric liquid-crystal layer inside it is tested in a light-resistant test, it produces air bubbles and therefore requires some improvement for practical use thereof.

### CITATION LIST

### Patent References

[Patent Reference 1] JP-A-6-263486
[Patent Reference 2] JP-A-2002-131531
[Patent Reference 3] JP-A-6-194517
[Patent Reference 4] Japanese Patent 4109914
[Patent Reference 5] JP-T 2009-514022
[Patent Reference 6] Japanese Patent 3500127
[Patent Reference 7] Japanese Patent 3745221
[Patent Reference 8] JP-A-2008-304762

### SUMMARY OF INVENTION

### Problems to be Resolved by the Invention

Accordingly, a first object of the invention is to improve the reflectivity characteristic of an infrared-light reflective plate that has a plurality of light-reflective layers each formed of fixed cholesteric liquid-crystal, without indispensable use of a λ/2 plate therein, and to improve the selective reflectivity characteristic of the infrared-light reflective plate that has a plurality of light-reflective layers each formed of fixed cholesteric liquid-crystal, thereby providing an infrared-light reflective plate especially having a high heat-shielding capability.

A second object of the invention is to improve light resistance of laminated glass having a cholesteric liquid crystal layer inside.

### Means of Solving the Problems

To achieve the above-mentioned first object, the present inventors have assiduously studied and, as a result, have found that, when two adjacent light reflective layers, formed of a fixed cholesteric liquid-crystal phase having an opposite optical rotation to each other (that is, having a right optical rotation or a left optical rotation), were disposed on a substrate, the laminate could reflect any of the left circularly-polarized light and the right circularly-polarized light falling within a predetermined wavelength range without being influenced by the optical properties of the substrate. They have found also that it was possible to broaden the reflective characteristics by further disposing another pair of light reflective layers, exhibiting selective reflectivity characteristics to another wavelength range and formed of a fixed cholesteric liquid-crystal phase having an opposite optical rotation to each other (that is, having a right optical rotation or a left optical rotation). However, they have found also that, when two adjacent light reflective layers, formed of a fixed cholesteric liquid-crystal phase, were prepared by a simple coating method, it was difficult to control the orientation of the upper light reflective layer, which didn't always provide preferred characteristics. On the basis of these findings, they have assiduously studied and, as a result, have found that when the reflection center wavelength of the lower light reflective layer was shorter than that of the upper light reflective layer, the selective reflectivity characteristics could be improved and an infrared-light reflective plate especially having a high heat-shielding capability could be obtained. Then, the inventors have made the present invention.

The means for achieving the first object are as follows.

[1] An infrared-light reflective plate reflecting an infrared-light of equal to or longer than 700 nm comprising

a substrate, and, on at least one of surfaces of the substrate,

at least four light-reflective layers, X1, X2, X3 and X4, formed of a fixed cholesteric liquid crystal phase, and disposed in this order from the substrate,

wherein the reflection center wavelengths of the light-reflective layers X1 and X2 are same with each other and are λ₁ (nm), and the two layers reflect circularly-polarized light in opposite directions;

the reflection center wavelengths of the light-reflective layers X3 and X4 are same with each other and are λ₂ (nm), and the two layers reflect circularly-polarized light in opposite directions; and

λ₁<λ₂ is satisfied.

[2] The infrared-light reflective plate of [1], wherein

the reflection center wavelength λ₁ (nm) of the light-reflective layers X1 and X2 falls within a range of from 800 to 1150 nm, and

the reflection center wavelength λ₂ (nm) of the light-reflective layers X3 and X4 falls within a range of from 1000 to 1400 nm.

[3] The infrared-light reflective plate of [1] or [2], wherein the light reflective layer X1 and the light reflective layer X3 reflect circularly-polarized light in a same direction; and

an orientation order of the light reflective layer X1 is higher than an orientation order of the light reflective layer X3.

[4] The infrared-light reflective plate of [1] or [2], wherein

the light reflective layer X1 and the light reflective layer X3 reflect circularly-polarized light in a same direction, and an orientation order of the light reflective layer X1 is higher than an orientation order of the light reflective layer X3; and

the light reflective layer X2 and the light reflective layer X4 reflect circularly-polarized light in a same direction, and an orientation order of the light reflective layer X2 is higher than an orientation order of the light reflective layer X4.

[5] The infrared-light reflective plate of any one of [1]-[4], wherein the light reflective layer X1 and the light reflective layer X3 comprise a right-rotation chiral agent; and

the light reflective layer X2 and the light reflective layer X4 comprise a left-rotation chiral agent.

[6] The infrared-light reflective plate of any one of [1]-[5], wherein

each of the light reflective layers X2, X3 and X4 is a layer which is formed by fixing a cholesteric liquid crystal phase of a liquid crystal composition applied to a surface of a lower light reflective layer.

[7] The infrared-light reflective plate of any one of [1]-[6], wherein the substrate is a polymer film.
[8] The infrared-light reflective plate of any one of [1]-[7], comprising an easy-adhesion layer as at least one outermost layer thereof.
[9] The infrared-light reflective plate of [8], wherein the easy-adhesion layer comprises polyvinyl butyral resin.
[10] The infrared-light reflective plate of [8], wherein the easy-adhesion layer comprises at least one ultraviolet absorber.
[11] A laminated glass comprising:

two glass plates, and, between them,

an infrared-light reflective plate of any one of [1]-[10].

To achieve the above-mentioned second object, the present inventors have assiduously studied and, as a result, have found that, when the laminated glass having a cholesteric liquid-crystal layer inside was subjected to a light-resistant test, the air bubbles were generated between the cholesteric liquid crystal layer and the interlayer. On the basis of this finding, they assiduously studied and, as a result, have found that, the air bubbles were generated due to the insufficient adhesiveness between the cholesteric liquid crystal layer and the interlayer, and also that it was possible to achieve the above-mentioned object by forming a layer capable of easily adhering to the interlayer as an outermost layer to contact with the interlayer. Then, the inventors have made the present invention.

The means for achieving the above-mentioned second object are as follows.

[12] A laminate comprising, at least,

a substrate, on a surface and/or a rear surface thereof,

one or two or more cholesteric liquid crystal layers, and

an easy-adhesion layer comprising a polyvinyl butyral resin as at least one outermost layer.

[13] The laminate of [12], wherein

the easy-adhesion layer is a layer which is formed by applying a coating liquid comprising a polyvinyl butyral resin to a surface of the cholesteric liquid crystal layer.

[14] The laminate of [12] or [13], comprising the easy-adhesion layer as both of outermost layers.
[15] The laminate of [12] or [13], comprising

the easy-adhesion layer as one of the outermost layers, and

an undercoat layer comprising one selected from an acrylic resin, an urethane resin and a polyester resin as another outermost layer.

[16] The laminate of any one of [12]-[15], wherein the easy-adhesion layer comprises at least one ultraviolet absorber.
[17] The laminate of [16], wherein the easy-adhesion layer is a layer which adjusts a transmittance value of an ultraviolet light having a wavelength of 380 nm or shorter to 0.1% or less.
[18] A laminated glass comprising
two glass plates having an interlayer on an inner surface thereof respectively, and, between them,
a reflective laminate of any one of [12]-[17].
   [19] The laminated glass of [18], wherein the interlayer comprises a polyvinyl butyral resin or an ethylene-vinyl acetate copolymer.

### Advantage of the Invention

According to the first invention, it is possible to improve the reflectivity characteristic of an infrared-light reflective plate that has a plurality of light-reflective layers each formed of fixed cholesteric liquid-crystal, without indispensable use of a 2J2 plate therein. And according to the invention, it is possible to improve the selective reflectivity characteristic of the infrared-light reflective plate that has a plurality of light-reflective layers each formed of fixed cholesteric liquid-crystal, thereby providing an infrared-light reflective plate especially having a high heat-shielding capability.

According to the second invention it is possible to improve light resistance of laminated glass having a cholesteric liquid crystal layer inside.

### BRIEF DESCRIPTION OF THE DRAWING

FIG. 1 is a cross-sectional view of one example of the infrared-light reflective plate of the first invention.

FIG. 2 is a cross-sectional view of one example of the infrared-light reflective plate of the first invention.

FIG. 3 is a cross-sectional view of one example of the infrared-light reflective plate of the first invention (as well as one example of the laminate of the second invention).

FIG. 4 is a cross-sectional view of one example of the infrared-light reflective plate of the first invention (as well as one example of the laminate of the second invention).

FIG. 5 is a cross-sectional view of one example of the laminate of the second invention.

FIG. 6 is a cross-sectional view of one example of the laminate of the second invention.

FIG. 7 is a cross-sectional view of one example of the laminated glass of the second invention.

FIG. 8 is a cross-sectional view of one example of the laminated glass of the second invention.

FIG. 9 is a microscope photograph used for explaining the orientation order of the layer formed of the fixed cholesteric liquid crystal phase.

### MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof.

In the description, the orientation order of a layer formed of a fixed cholesteric liquid crystal phase is defined as follows.

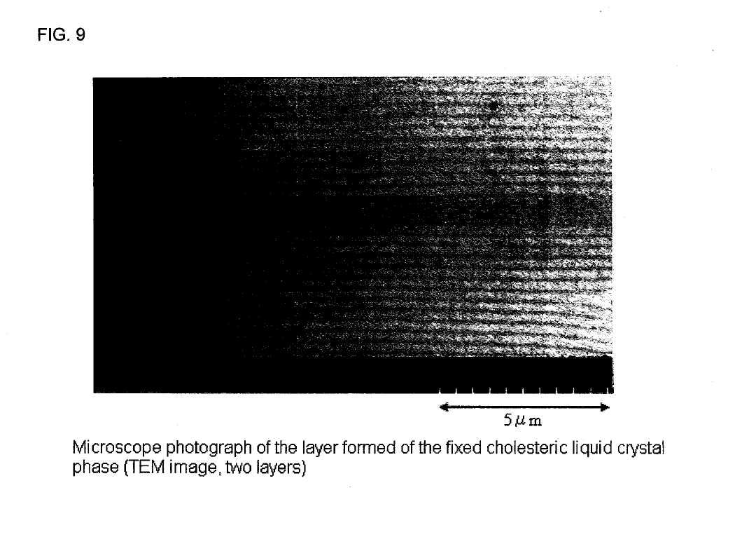

In the description, the orientation order of a layer formed of a fixed cholesteric liquid crystal phase is defined as an averaged angle between the film-plane and the helical axis of the cholesteric liquid crystal phase, and is one of the indicators showing the uniformity of the orientation of liquid crystal molecules. The angle may be confirmed by any electron microscope observation of any cross-sectional surface of a layer formed of a fixed cholesteric liquid crystal phase. A parallel gray image having a ½ cycle of the helical pitch of the cholesteric liquid crystal phase may be observed in the layer plane of any sample having the highest order. One example of the microscope photographs is shown in FIG. 9. The gray image relates to the azimuth direction of the cholesteric liquid crystal, and that the well-regulated stripe pattern is parallel to the layer plane means that the helical axis of the cholesteric liquid crystal phase is perpendicular to the layer plane uniformly. On the other hand, in any sample having a low order, there may be the area in which the stripe pattern, having the same pitch as that of the described above, is not parallel to the layer plane, or that is, there may be the area in which the helical axis is out of alignment with the normal line of the layer plane. In any sample having a less order, the ratio of the area may become larger or the misalignment angle may become larger. Accordingly, the orientation order is concretely calculated as follows. A cross-sectional surface of a sample is subjected to an microscope observation; a gray image, emerging with a ½ cycle of the helical pitch of the cholesteric liquid crystal, is obtained; the angle between the layer plane and the perpendicular line of each of the stripe patterns is measured; and then the averaged value thereof can be calculated as an orientation order of the sample.

And in this description, the refractivity anisotropy, Δn, of a layer formed of a fixed cholesteric liquid-crystal phase is defined as follows.

In this description, the refractivity anisotropy, Δn, of a layer formed of a fixed cholesteric liquid-crystal phase means the value of Δn for a light of a wavelength at which the layer exhibits the selective reflectivity characteristic (concretely, at a wavelength around 1000 nm). Concretely, first, as a sample, a layer of a fixed cholesteric liquid-crystal phase in which the helical axes of the liquid-crystal molecules are aligned uniformly to a layer plane is formed on a substrate (such as glass and film) subjected to an alignment treatment or having an alignment film thereon. The selective reflection of the layer is determined, and its peak width Hw is measured. Separately, the helical pitch p of the sample is measured. The helical pitch may be measured on the TEM picture of the cross section of the sample. The data are introduced into the following formula, and the refractivity anisotropy Δn of the sample is thereby determined.

Δn=Hw/p

In this description, for the wording that “the reflection center wavelength of each layer is the same”, needless-to-say, the error generally acceptable in the technical field to which the present invention belongs is naturally taken into consideration. In general, the difference of around ±30 nm or so will be acceptable for the same reflection center wavelength.

### First Invention

Hereinafter, embodiments of the first invention will be described with reference to the drawings.

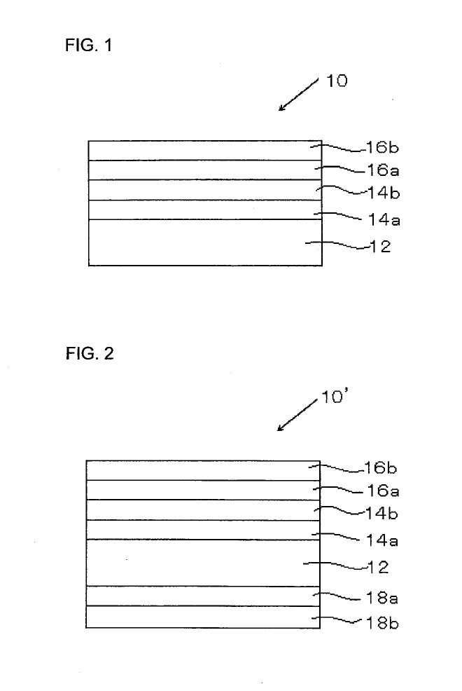

The infrared-light reflective plate shown in FIG. 1 has, on one surface of the substrate 12, light-reflective layers 14a, 14b, 16a and 16b each formed of a fixed cholesteric liquid-crystal phase. The substrate 12 is, for example, a polymer film, and its optical properties are not specifically defined. In the invention, in particular, a member of which in-plane retardation Re fluctuates may be used as the substrate. In this point, the invention is differentiated from existing techniques where a λ/2 plate is used as the substrate and where its optical properties are willingly utilized for improving the light-reflective characteristic of the reflector. However, the invention does not hinder the use of a retarder having an accurately-regulated retardation such as λ/2 plate or the like, as the substrate 12.

Concretely, not specifically defined in point of the optical properties thereof, the substrate 12 may be a retarder having retardation or may also be an optically-isotropic substrate. In other words, the substrate 12 is not required to be a retarder such as a λ/2 plate or the like of which the optical properties are strictly controlled. In the invention, the substrate 12 may be formed of a polymer film or the like of which the fluctuation of in-plane retardation at a wavelength of 1000 nm, Re (1000) is 20 nm or more. Furthermore, in the invention, the substrate 12 may be formed of a polymer film or the like of which the fluctuation of in-plane retardation at a wavelength of 1000 nm, Re (1000) is 100 nm or more. In-plane retardation of the substrate is not also specifically defined. For example, a retarder or the like of which in-plane retardation at a wavelength of 1000 nm, Re (1000) is from 800 to 13000 nm may be used. Examples of the polymer film usable for the substrate are described later.

The light-reflective layers 14a, 14b, 16a and 16b are layers each formed of a fixed cholesteric liquid-crystal phase, and therefore, they exhibit selective light reflectivity of reflecting a light having a specific wavelength based on the helical pitch of the cholesteric liquid-crystal phase in each layer. In this embodiment, the helical directions of the respective cholesteric liquid-crystal phases in the neighboring light-reflective layers 14a and 14b are opposite to each other, but the reflection center wavelength λ₁₄ of the two layers is the same. Similarly, the helical directions of the respective cholesteric liquid-crystal phases in the neighboring light-reflective layers 16a and 16b are opposite to each other, but the reflection center wavelength λ₁₆ of the two layers is the same. In this embodiment, λ₁₄≠λ₁₆, and therefore, the light-reflective layers 14a and 14b selectively reflect the left circularly-polarized light and the right circularly-polarized light at a predetermined wavelength λ₁₄, and the light-reflective layers 16a and 16b selectively reflect the left circularly-polarized light and the right circularly-polarized light at a wavelength λ₁₆ that is longer than the wavelength λ₁₄.

The infrared-light reflective plate 10, shown in FIG. 1, reflects the infrared-light with a wavelength of 700 nm or longer; and therefore, both of the selective reflection center wavelength λ₁₄ of the light-reflective layers 14a and 14b and the selective reflection center wavelength λ₁₆ of the light-reflective layers 16a and 16b are preferably equal to or longer than 700 nm. According to the infrared-light reflective plate 10, λ₁₄<λ₁₆ is satisfied. According to an example, the selective reflection center wavelength λ₁₄ is from 800 nm to 1150 nm (preferably, from 850 nm to 1100 nm, or from 800 nm to 1050 nm), and the selective reflection center wavelength λ₁₆ is from 1000 nm to 1400 nm (preferably, from 1050 nm to 1350 nm, or from 1050 nm to 1300 nm).

The helical pitch of the cholesteric liquid-crystal layer showing the above-mentioned reflection center wavelength is, in general, from 500 to 1350 nm or so (preferably from 500 to 900 nm or so, or more preferably from 550 to 800 nm or so). And the thickness of each of the light reflective layers is from 1 micro meter to 8 micro meters or so (preferably from 3 to 8 micro meters or so). However, the invention is not limited to the range. By selecting and controlling the type and the concentration of the material (mainly liquid-crystal material and chiral agent) for use in forming the layers, the light-reflective layer having a desired helical pitch can be formed. The thickness of the layer may be controlled to fall within the desired range, by controlling the coating amount.

As described above, in the neighboring light-reflective layers 14a and 14b, the helical directions of the respective cholesteric liquid-crystal phases are opposite to each other; and similarly, in the neighboring light-reflective layers 16a and 16b, the helical directions of the respective cholesteric liquid-crystal phases are opposite to each other. In that manner, arranging light-reflective layers adjacent to each other, in which the cholesteric liquid-crystal phases are aligned in the direction opposite to each other and of which the selective reflections center wavelength are the same, enables reflection of both left circularly-polarized light and right circularly-polarized light at the same wavelength. This effect has no relation with the optical properties of the substrate 12, and is obtained without any influence of the optical properties of the substrate 12.

On the other hand, forming two adjacent light reflective layers of the desired cholesteric liquid crystal phase has been considered difficult. For example, the method comprising forming each of the layers of the desired cholesteric liquid crystal phase on a temporary substrate independently, and then laminating them to bond to each other is known; and the method comprising preparing a liquid crystal composition by mixing materials capable of forming a cholesteric liquid crystal phase suitable to each of the light reflective layers, applying the liquid crystal composition to a surface of a support to form a coated layer, and then allowing the coated layer to form a phase separation during drying and thermal alignment, to form two cholesteric liquid crystal layer is known. However, according to the former method employing a lamination, there is a problem that the cost may increase; and according to the latter method, there is a problem that the thickness may become thicker as a whole, that the orientation state may worsen, or that the orientation state may also worsen due to the fluctuation at the interface of the phase separation. Any expensive step such as a lamination step or any step beyond control such as a phase-separation step may be unnecessary if the laminated structure can be obtained by repeating the steps of coating, which is preferable. However, according to the method comprising a plurality of repetition of a coating step, a drying step and a fixing step to create a laminated structure of the light reflective layers formed of a cholesteric liquid crystal phase, it was difficult to control the orientation during forming any upper layer. The present inventors have assiduously studied and, as a result, have found that if there was any orientation-disorder at the surface of the light reflective layer of the liquid crystal composition, it was impossible to form the desired cholesteric liquid crystal phase on the surface of the light reflective layer because the orientation of the upper light reflective layer was disordered because of the influence of the orientation-disorder thereof, which was one of the factor. If the orientation order of the cholesteric liquid crystal phase becomes low, the profile of the selective reflection peak may become broader or the haze may increase due to the orientation defects, which is not preferable. Namely, if the orientation of the upper light reflective layer tends to be easily disordered, the selective reflectivity characteristics attributed to the upper layer may not function fully. On the other hand, in order to improve the infrared-light reflective plate in terms of the heat-shielding capability, it is more important to block the light with a shorter wavelength, which contributes to the temperature-raise more, among the infrared-light. According to the invention, the reflection center wavelength of a pair of the lower light-reflective layers is shorter than the reflection center wavelength of a pair of the upper light-reflective layers, and by employing such a structure, even if creating the laminated structure of the light reflective layers by coating, it is possible to provide an infrared-light reflective plate excellent in the heat-shielding capability.

Namely, in FIG. 1, the reflection center wavelength λ₁₄ of a pair of the lower light-reflective layers 14a and 14b satisfies λ₁₄<λ₁₆ in relation to the reflection center wavelength λ₁₆ of a pair of the upper light-reflective layers 16a and 16b. As described above, if the layers are formed according to the coating method, the orientation of the upper layer tends to be more disordered than that of the lower layer, and therefore, the orientation order is lowered along the order of the light reflective layer 14a, 14b, 16a and 16b. However, even if the orientation order of the pair of the upper light reflective layers 16a and 16b is lower than that of the pair of the lower light reflective layers 14a and 14b, the lower layers 14a and 14b having the high orientation order can reflect the left and right circularly-polarized lights having a shorter wavelength (λ₁₄) contributing to the temperature-raise, with a high selective reflectivity. As a result, the heat-shielding capability isn't lowered remarkably. In terms of the heat-shielding capability, the orientation orders of the light reflective layers 14a and 14b are preferably equal to or higher than 80°, or needless-to-say, most preferably 90°. On the other hand, the orientation orders of the light reflective layers 16a and 16b may be from 70 to 80° or so.

According to the coating method, comparing the light reflective layer 14a with the light reflective layer 14b or comparing the light reflective layer 16a with the light reflective layer 16b, the orientation order of the upper light reflective layer 14b or 16b tends to be lower than that of the lower layer 14a or 16a respectively. If there is such a difference of the orientation order between the pair of the light reflective layers having the same reflection center wavelength and having the helical structure different from each other, the selective reflection characteristics may be lowered. For solving this problem, preferably, the refractive anisotropy Δn₁₄ₐ of the light reflective layer 14a and the refractive anisotropy Δn_{14b} of the light reflective layer 14b satisfy Δn_{14b}<Δn₁₄ₐ; and the refractive anisotropy Δn₁₆ₐ of the light reflective layer 16a and the refractive anisotropy Δn_{16b} of the light reflective layer 16b satisfy Δn_{16b}<Δn₁₆ₐ. If the relation is satisfied, the light reflective layers 14b and 16b having the desired light reflective characteristics and having the good orientation state can be prepared even by applying the liquid crystal compositions to the surface of the light reflective layers 14a and 16a respectively to form a cholesteric liquid crystal phase, and then fixing the cholesteric liquid crystal phase. The details about the relation between the refractive anisotropy satisfying the above-described condition and this effect are not known, however, one presumption would be as follows. The value of Δn of a light reflective layer formed of a fixed cholesteric liquid crystal layer may be varied depending on any condition in the polymerization for fixing the cholesteric liquid crystal phase or on the formulation of the liquid crystal composition to be used for the layer, and usually, it may be close to the value of Δn of the rod-like liquid crystal which is contained in the liquid crystal composition at a highest ratio. Therefore, the light reflective layer formed by using any liquid crystal composition containing a rod-like liquid crystal having a higher Δn as a main ingredient may naturally have higher Δn. On the other hand, if the concentration of a chiral agent to be added to the liquid crystal composition is increased for obtaining the desired helical pitch, the ratio of the rod-like liquid crystal compound is decreased relatively. Accordingly, the lower light reflective layer formed by using any liquid crystal composition, containing a rod-like liquid crystal, originally having a higher Δn, and a chiral agent in a smaller amount, may have a higher Δn. The rod-like liquid crystal having a high Δn may form a desired cholesteric liquid crystal phase state without being added with any additive such as a chiral agent, and therefore, the lower layer may be formed without any disorder at the interface or any disorder in the orientation caused by the presence of any additive. Therefore, it may be possible to apply the liquid crystal composition for the upper layer to the surface of the lower layer having a good orientation state without any orientation disorder, and also to form the cholesteric liquid crystal phase more stably. The above-mentioned effect may be considered to be obtained since the upper light reflective layer, having the desired characteristics, can be formed in this way.

As an example, it is provided an example wherein the light reflective layer 14a is formed of a liquid crystal composition containing a right-rotation chiral agent, or that is, the light reflective layer 14a reflects a right circularly-polarized light, and, as well as the light reflective layer 14a, the light reflective layer 16a is formed of a liquid crystal composition containing a right-rotation chiral agent, or that is, the light reflective layer 16a reflects a right circularly-polarized light; and the light reflective layer 14b is formed of a liquid crystal composition containing a left-rotation chiral agent, or that is, the light reflective layer 14b reflects a left circularly-polarized light, and, as well as the light reflective layer 14b, the light reflective layer 16b is formed of a liquid crystal composition containing a left-rotation chiral agent, or that is, the light reflective layer 16b reflects a left circularly-polarized light. There are many commercially available right-rotation chiral agents having a higher twisting power, compared with the commercially available left-rotation chiral agents. If any chiral agent having a higher twisting power is used, an amount thereof may be reduced, and therefore, according to the above-described example, the light reflective layers satisfy the conditions of Δn_{14b}<Δn₁₄ₐ and Δn_{16b}<Δn₁₆ₐ can be prepared respectively by using the material selected from a wide variety of materials.

FIG. 2 shows a cross-sectional view of another embodiment of the infrared-light reflective plate of the invention. As well as the infrared-light reflective plate 10 shown in FIG. 1, the infrared-light reflective plate 10′ shown in FIG. 2 has light-reflective layers 14a, 14b, 16a and 16b on one surface of the substrate 12. The characteristics of the layers and the relations thereof are same as those in FIG. 1. The infrared-light reflective plate 10′ has also light-reflective layers 18a and 18b on another surface of the substrate 12. As well as the light reflective layers 14a and 14b or the light reflective layers 16a and 16b, the light reflective layers 18a and 18b have the feature wherein the helical directions of the respective cholesteric liquid-crystal phases in the light-reflective layers 18a and 18b are opposite to each other, but the reflection center wavelengths of the two layers are same with each other. However, the reflection center wavelength λ₁₈ of the light reflective layers 18a and 18b are not same as the reflection center wavelength λ₁₄ of the light reflective layers 14a and 14b or the reflection center wavelength λ₁₆ of the light reflective layers 16a and 16b. Therefore, as well as the infrared-light reflective plate 10, the infrared-light reflective plate 10′ has not only the selective reflection characteristics for the right and left circularly-polarized lights with the center reflection wavelengths of λ₁₄ and λ₁₆ attributed to the light reflective layers 14a and 14b and the light reflective layers 16a and 16b respectively but also the selective reflection characteristics for the right and left circularly-polarized lights with the center reflection wavelengths λ₁₈ attributed to the light reflective layers 18a and 18b; and the selective reflection characteristics thereof are more broadened.

According to one example of the invention, the center selection wavelength λ₁₄ is from 800 to 1000 nm (or more preferably from 850 to 950 nm), λ₁₆ is from 900 to 1100 nm (or more preferably from 950 to 1050), λ₁₈ is from 1000 to 1200 nm (or more preferably from 1050 to 1150 nm); and the center reflection wavelength of another pair of the light reflective layer is from 1100 to 1300 nm (or more preferably from 1150 to 1250 nm). However, the invention is not limited to this example.

The light reflective layers 18a and 18b may be prepared according to any method. As described above, one example of the simpler method is as follows. A liquid crystal composition is applied to a surface of a substrate to form a cholesteric liquid crystal phase, and then the orientation state is fixed to form a light reflective layer 18a. As well as the light reflective layer 18a, a light reflective layer 18b is prepared on the light reflective layer 18a. According to this method, the surface texture or the orientation state of the lower layer affects the orientation state of the upper layer formed on the lower layer, and therefore, the refractive anisotropy Δn₁₈ₐ of the light reflective layer 18a and the refractive anisotropy Δn_{18b} of the light reflective layer 18b preferably satisfy the relation of Δn_{18b}<Δn₁₈ₐ.

The embodiment of the infrared-light reflective plate of the invention is not limited to those of FIG. 1 and FIG. 2. In other embodiments, three (six in total) or more pairs of the light-reflective layers may be laminated on one surface of the substrate. Or, as shown in FIG. 2, two (eight in total) or more pairs of light-reflective layers may be formed on both surfaces of the substrate. And, as shown in FIG. 2, the numbers of the light reflective layers on one surface and another surface of the substrate may be same or different from each other. And still another embodiment may have two or more pairs of light-reflective layers each having the same reflection center wavelength.

Needless-to-say, the infrared-light reflective plate of the invention may be combined with any other infrared-light reflective plate for the purpose of further broadening the reflection wavelength range. In addition, the reflector may have a light-reflective layer capable of reflecting a light having a predetermined wavelength on the basis of any other principle than the selective reflectivity characteristic of cholesteric liquid-crystal phase. Regarding the members capable of being combined with the reflector of the invention, there may be mentioned composite films and the layers constituting the films described in JP-T 4-504555, as well as multilayer laminates described in JP-T 2008-545556, etc.

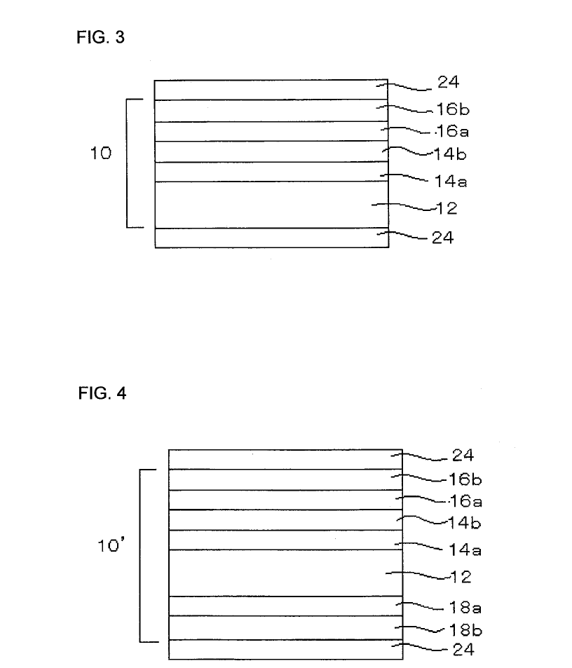

The infrared-light reflective plate of the present invention may have an easy-adhesion layer as an outermost layer thereof for easily adhering to another member. FIG. 3 and FIG. 4 show the examples having an easy-adhesion layer 24 as an outermost layer of the infrared-light reflective plates 10 and 10′ shown in FIG. 1 and FIG. 2 respectively. Preferable examples of the easy-adhesion layer 24 are same as those of the easy-adhesion layer to be used in the second present invention described later. For example, the easy-adhesion layer 24 containing polyvinyl butyral resin may have a high adhesive ability for an interlayer of a laminated glass, and therefore, the infrared-light reflective plate 10 or 10′ having such an easy-adhesion layer may be incorporated in a laminated glass easily. Since the easy-adhesion layer 24 has a high adhesive ability for the interlayer, the laminated glass may be excellent in light-resistance and any degradation such as generated air bubbles may be hardly found therein even if being subjected to an irradiation of natural light for a long time, which is preferable. If an ultraviolet absorber is added to the easy-adhesion layer 24, the light-resistance may be more improved, and it may be possible also to prevent any yellowish coloration caused after being subjected to an irradiation of natural light for a long time, which is preferable.

Next, examples of the material and the method for preparing the infrared-light reflective plate of the invention are described in detail.

### 1. Materials for Light-Reflective Layers

According to the invention, for preparing each of the light-reflective layers, a curable liquid crystal composition is preferably used. One example of the liquid crystal composition contains at least a rod-like liquid crystal, an optically-active compound (chiral agent) and a polymerization initiator. Two or more types of each of the ingredients may be used. For example, polymerizable and non-polymerizable liquid-crystal compounds may be used in combination. Or, low-molecular weight or high-molecular weight liquid-crystal compounds may be used in combination. Furthermore, each of the light-reflective layers may contain at least one additive selected from any additives such as homogenous-alignment promoter, anti-unevenness agent, anti-repelling agent and polymerizable monomer for improving the uniformity of alignment, the coating property or the film strength. If necessary, the liquid crystal composition may contain any polymerization inhibitor, antioxidant, ultraviolet absorber, light-stabilization agent or the like in an amount unless the optical properties thereof are lowered.

### (1) Rod-like Liquid Crystal Compound

Examples of the rod-like liquid crystal compound which can be used in the invention include nematic rod-like liquid crystal compounds. Preferable examples of the nematic rod-like liquid crystal include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles. In the invention, the liquid crystal compound can be selected from not only low-molecular weight compounds but also high-molecular weight compounds.

The rod-like liquid crystal compound to be used in the invention may be polymerizable or not polymerizable. Examples of the rod-like liquid crystal having no polymerizable group are described in many documents such as Y. Goto et. al., Mol. Cryst. Liq. Cryst. 1995, Vol. 260, pp. 23-28.

A polymerizable rod-like liquid crystal compound may be prepared by introducing a polymerizable group in rod-liquid crystal compound. Examples of the polymerizable group include an unsaturated polymerizable group, epoxy group, and aziridinyl group; and an unsaturated polymerizable group is preferable; and an ethylene unsaturated polymerizable group is especially preferable. The polymerizable group may be introduced in a rod-like liquid crystal compound according to any method. The number of the polymerizable group in the polymerizable rod-like liquid crystal compound is preferably from 1 to 6 and more preferably from 1 to 3. Examples of the polymerizable rod-like liquid crystal compound include those described in Makromol. Chem., vol. 190, p. 2255 (1989), Advanced Materials, vol. 5, p. 107 (1993), U.S. Pat. No. 4,683,327, U.S. Pat. No. 5,622,648, U.S. Pat. No. 5,770,107, WO95/22586, WO95/24455, WO97/00600, WO98/23580, WO98/52905, JPA No. 1-272551, JPA No. 6-16616, JPA No. 7-110469, JPA No. 11-80081 and JPA No. 2001-328973. Plural types of polymerizable rod-like liquid crystal compounds may be used in combination. Using plural types of polymerizable rod-like liquid crystal compounds may contribute to lowering the alignment temperature.

### (2) Optically-Active Compound (Chiral Agent)

The liquid crystal composition is capable of forming a cholesteric liquid crystal phase, and preferably contains a optically-active compound. However, if the rod-like liquid crystal compound having a chiral carbon in its molecule is used, some of the compositions containing such a rod-like liquid crystal compound may be capable of stably forming a cholesteric liquid crystal phase even if they don't contain any optically-active compound. The optically-active compound may be selected from any known chiral agents such as those used in twisted-nematic (TN) and super-twisted-nematic (STN) modes, which are described, for example, in “Ekisho Debaisu Handobukku (Liquid Crystal Device Handbook)”, Third Chapter, 4-3 Chapter, p. 199, edited by No. 142 Committee of Japan Society for the Promotion of Science, published by the Nikkan Kogyo Shimbun, Ltd., in 1989. Although, generally, an optically-active compound has a chiral carbon in its molecule, axially chiral compounds and planar chiral compound, having no chiral carbon, may be used as a chiral compound in the invention. Examples of the axially chiral compound or the planar chiral compound include binaphthyl, helicene, paracyclophane and derivatives thereof. The optically-active compound (chiral compound) may have at least one polymerizable group. Using a polymerizable optically-active compound along with a polymerizable rod-like compound, it is possible to obtain a polymer having repeating units derived from the optically-active compound and the rod-like liquid crystal compound respectively by carrying out the polymerization thereof. In such an embodiment, the polymerizable group in the optically-active compound is preferably same as that in the rod-like liquid crystal compound. Accordingly, the polymerizable group in the optically-active compound is preferably selected from an unsaturated polymerizable group, epoxy group and aziridinyl group; and an unsaturated polymerizable group is preferable; and an ethylene unsaturated polymerizable group is especially preferable.

The optically-active compound may be selected from liquid crystal compounds.

An amount of the optically-active compound is preferably from 1 to 30% by mole with respect to an amount of the rod-like liquid crystal compound used along with it. A smaller amount of the optically-active compound is more preferable since influence thereof on liquid crystallinity may be small. Accordingly, optically-active compounds having a strong helical twisting power are preferable since they may achieve the desired helical pitch by being added in a small amount. Examples of such an optically-active compound having a strong helical twisting power include those described in JPA 2003-287623.

According to the infrared-light reflective plate of the invention, the light reflective layers, formed of a cholesteric liquid crystal phase with a helical direction opposite to each other, are adjacent to each other. As a preferable example, exemplified is the infrared-light reflective plate wherein the upper layer of the pair of the light reflective layers adjacent to each other has the larger refractive anisotropy compared with the lower layer thereof. As described above, the refractive anisotropy of a layer is affected by the refractive anisotropy of the liquid crystal material to be used for preparing the layer or an amount of the chiral agent to be added to the layer. The number of commercially available right-rotation chiral agents having a strong twisting force is larger than that of commercially available left-rotation chiral agents having a strong twisting force. Therefore, a necessary amount of the right-rotation chiral agent may be less than that of the left-rotation chiral agent for preparing a cholesteric liquid crystal phase having a same helical pitch, which results in forming the layer having the smaller refractive anisotropy, Δn. The embodiment wherein the composition containing any right-rotation chiral agent is used for preparing the lower light reflective layer and the composition containing any left-rotation chiral agent is used for preparing the upper light reflective layer is preferable since the scope of choices of the materials is widened.

### (3) Polymerization Initiator

The liquid crystal composition to be used for preparing each of the light-reflective layers is preferably a polymerizable liquid crystal composition; and on its own, the composition preferably contains at least one polymerization initiator. According to the invention, the polymerization may be carried out under irradiation of ultraviolet light, and the polymerization initiator is preferably selected from photo-polymerization initiators capable of initiating polymerizations by irradiation of ultraviolet light. Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication “Tokkai” No. S60-105667 and U.S. Pat. No. 4,239,850), and oxadiazole compounds (those described in U.S. Pat. No. 4,212,970).

An amount of the photo-polymerization initiator is preferably from 0.1 to 20% by mass, more preferably from 1 to 8% by mass, with respect to the liquid crystal composition (the solid content when the composition is a coating liquid).

### (4) Alignment Controlling Agent

Any alignment controlling agent, which can contribute to stably or promptly forming a cholesteric liquid crystal phase, may be added to the liquid crystal composition. Examples of the alignment controlling agent include fluorine-containing (meth)acrylate series polymers and compounds represented by formula (X1)-(X3). Two or more types selected from these compounds may be used in combination. These compounds may contribute to aligning liquid crystal molecules with a small tilt angle or horizontally at the air-interface alignment. It is to be understood that the term “horizontal alignment” in the specification means that the direction of long axis of a liquid crystalline molecule is parallel to the layer plane, wherein strict parallelness is not always necessary; and means, in this specification, that a tilt angle of the mean direction of long axes of liquid crystalline molecules with respect to the horizontal plane is smaller than 20°. The layer in which liquid crystal molecules are horizontally aligned at the air-interface may hardly suffer from alignment defects, and may have a high transparency for a visible light and have a high reflection rate. On the other hand, the layer in which liquid crystal molecules are aligned with a large tilt angle may suffer from the finger-print pattern, and may have a low reflective rate, high haze and diffraction characteristics, because of the misalignment between the helical axis of the cholesteric liquid crystal phase and the normal line of the layer surface.

Examples of the fluorine-containing (meth)acrylate series polymer, which can be used as an alignment controlling agent, include those described in JPA 2007-272185, [0018]-[0043].

The compounds represented by formula (X1)-(X3), which can be used as an alignment controlling agent, will be describe in detail respectively.

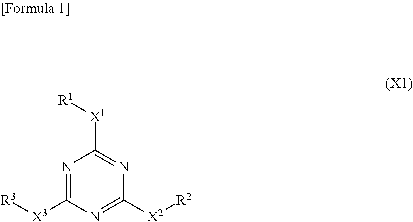

In the formula, R¹, R² and R³ each independently represent a hydrogen atom or a substituent group; X¹, X² and X³ each independently represent a single bond or divalent linking group. The substituent group represented by R¹-R³ respectively is preferably a substituted or non-substituted alkyl group (more preferably a non-substituted alkyl or a fluorinated alkyl group), an aryl group (more preferably an aryl group having at least one fluorinated alkyl group), a substituted or non-substituted amino group, an alkoxy group, an alkylthio group, or a halogen atom. The divalent linking group represented by X¹, X² and X³ respectively is preferably selected from the group consisting of an alkylene group, an alkenylene group, a divalent aryl group, a divalent heterocyclic group, —CO—, —NR^{a}— (where R^{a} represents a C₁₋₅ alkyl group or a hydrogen atom), —O—, —S—, —SO—, —SO₂— and any combinations thereof. The divalent linking group is preferably selected from the group consisting of an alkylene group, a phenylene group, —CO—, —O—, —S—, —SO₂— and any combinations thereof. The number of carbon atom(s) in the alkylene group is preferably from 1 to 12. The number of carbon atoms in the alkenylene group is preferably from 2 to 12. The number of carbon atoms in the aryl group is preferably from 6 to 10.

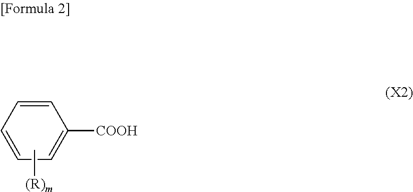

In the formula, R represents a substituent group; and m is an integer of from 0 to 5. When m is equal to or more than 2, two or more R are same or different from each other. Preferable examples of the substituent group represented by R are same as those exemplified above as an example of R¹, R² or R³ in formula (X1). In the formula, m is preferably from 1 to 3, and is especially preferably 2 or 3.

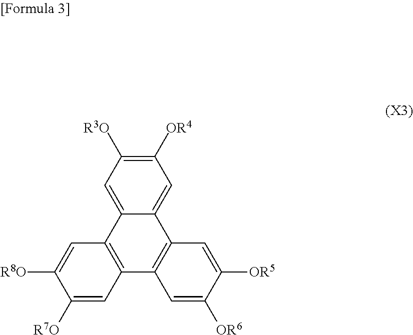

In the formula, R⁴, R⁵, R⁶, R⁷, R⁸ and R⁹ each independently represent a hydrogen atom or a substituent group. Preferable examples of R⁴, R⁵, R⁶, R⁷, R⁸ or R⁹ include those exemplified above as an example of R¹, R² or R³ in formula (X1).

Examples of the compound represented by formula (X1), (X2) or (X3), which can be used as an alignment controlling agent, include the compounds described in JPA 2005-99248.

One compound of formula (X1), (X2) or (X3) may be used alone, or two or more compounds of formula (X1), (X2) or (X3) may be used in combination.

An amount of the compound represented by formula (X1), (X2) or (X3) to be added to the liquid crystal composition is preferably from 0.01 to 10% by mass, more preferably from 0.01 to 5% by mass, or especially preferably from 0.02 to 1 by mass, with respect to an amount of the liquid crystal compound.

### 2. Substrate

The infrared-light reflective plate of the invention has a substrate, and the substrate may not be limited in terms of materials or optical properties as long as it is self-supporting and can support the light-reflective layers. In some applications, the substrate may be required to have a high transmission for a visible light. The substrate may be selected from specific retardation plates such as a λ/2 plate, which are produced according to the method controlled for obtaining the specific optical properties; or the substrate may be selected from polymer films of which variation in in-plane retardation is large, more particularly, fluctuation in Re (1000), which is in-plane retardation at a wavelength of 1000 nm, is equal to or more than 20 nm or 100 nm, which cannot be used as a specific retardation plate. For example, a retarder or the like of which in-plane retardation at a wavelength of 1000 nm, Re (1000) is from 800 to 13000 nm may be used.

Polymer films having a high transmission for a visible light include those used in display devices such as a liquid crystal display device as an optical film. Preferable examples of the polymer film which can be used as a substrate include poly ester films such as polyethylene terephthalate (PET), polybutylene and polyethylene naphthalate (PEN) films; polycarbonate (PC) films; polymethylmethacrylate films; polyolefin films such as polyethylene and polypropylene films; polyimide films, triacetyl cellulose (TAC) films.

### 3. Production Method for Infrared-Light Reflective Plate

Preferably, the infrared-light reflective plate of the invention is produced according to a coating method. One example of the production method includes at least the following steps:

(1) applying a curable liquid-crystal composition to the surface of a substrate or the like to form a cholesteric liquid-crystal phase thereon, and

(2) irradiating the curable liquid-crystal composition with ultraviolet light for promoting the curing reaction, thereby fixing the cholesteric liquid-crystal phase and then forming a light-reflective layer.

The steps of (1) and (2) are repeated four times on one surface of a substrate to produce the infrared-light reflective plate as shown in FIG. 1. The steps of (1) and (2) are repeated four times on one surface of a substrate, and, previously, subsequently or simultaneously, the steps of (1) and (2) are repeated twice on another surface of the substrate to produce the infrared-light reflective plate as shown in FIG. 2.

In the step (1), first, a curable liquid-crystal composition is applied onto the surface of a substrate or an undercoat layer. The curable liquid-crystal composition is preferably prepared as a coating liquid of the material dissolved and/or dispersed in a solvent. The coating liquid may be applied to the substrate or the like, according to various methods of a wire bar coating method, an extrusion coating method, a direct gravure coating method, a reverse gravure coating method, a die coating method or the like. As the case may be, an inkjet apparatus may be used in which a liquid-crystal composition may be jetted out through a nozzle to form the intended coating film.

Next, the coating film of the curable liquid-crystal composition formed on the surface of the substrate or the like is made to have a cholesteric liquid-crystal phase. In an embodiment where the curable liquid-crystal composition is prepared as a coating liquid that contains a solvent, the coating film may be dried to remove the solvent, thereby the coating film may be made to have the intended cholesteric liquid-crystal phase. If desired, the coating film may be heated up to the transition temperature to the cholesteric liquid-crystal phase. For example, the coating film is once heated up to the temperature of the isotropic phase, and then cooled to the cholesteric liquid-crystal phase transition temperature, whereby the film may stably have the intended cholesteric liquid-crystal phase. The liquid-crystal transition temperature of the curable liquid-crystal composition is preferably within a range of from 10 to 250 degrees Celsius from the viewpoint of the production aptitude, more preferably within a range of from 10 to 150 degrees Celsius. When the temperature is lower than 10 degrees Celsius, the coating film may require a cooling step or the like for cooling it to the temperature range within which the film could exhibit a liquid-crystal phase. On the other hand, when the temperature is higher than 200 degrees Celsius, the coating film may require a higher temperature in order that it could be in an isotropic liquid state at a higher temperature than the temperature range within which the film once exhibits a liquid-crystal phase; and this is disadvantageous from the viewpoint of heat energy dissipation, substrate deformation, degradation, etc.

Next, in the step (2), the coating film in a cholesteric liquid-crystal state is irradiated with ultraviolet light to promote the curing reaction thereof. For ultraviolet irradiation, used is a light source of an ultraviolet lamp or the like. In this step, the ultraviolet irradiation promotes the curing reaction of the liquid-crystal composition, and the cholesteric liquid-crystal phase is thereby fixed and the intended light-reflective layer is thus formed.

The ultraviolet irradiation energy dose is not specifically defined, but in general, it is preferably from 100 mJ/cm² to 800 mJ/cm² or so. Not specifically defined, the time for ultraviolet radiation to the coating film may be determined from the viewpoint of both the sufficient strength of the cured film and the producibility thereof.

For promoting the curing reaction, ultraviolet irradiation may be attained under heat. The temperature in ultraviolet irradiation is preferably kept within a temperature range within which the cholesteric liquid-crystal phase can be kept safely as such with no disturbance. The oxygen concentration in the atmosphere participates in the degree of polymerization of the cured film. Accordingly, in case where the cured film could not have the intended degree of polymerization in air and the film strength is therefore insufficient, preferably, the oxygen concentration in the atmosphere is lowered according to a method of nitrogen purging or the like. The preferred oxygen concentration is at most 10%, more preferably at most 7%, most preferably at most 3%. The reaction rate of the curing reaction (for example, polymerization reaction) to be promoted by the ultraviolet irradiation is preferably at least 70% from the viewpoint of keeping the mechanical strength of the layer and for the purpose preventing unreacted matters from flowing out of the layer, more preferably at least 80%, even more preferably at least 90%. For increasing the reaction rate, a method of increasing the ultraviolet irradiation dose or a method of carrying out the polymerization in a nitrogen atmosphere or under a heating condition may be effective. Also employable is a method of keeping the polymerization system, after once polymerized, in a higher temperature condition than the polymerization temperature to thereby further promote the thermal polymerization reaction, or a method of again irradiating the reaction system with ultraviolet light (in this, however, the additional ultraviolet irradiation should be attained under the condition that satisfies the condition of the invention). The reaction rate may be determined by measuring the infrared oscillation spectrum of the reactive group (for example, the polymerizing group) before and after the reaction, followed by comparing the data before and after the reaction.

In the above step, the cholesteric liquid-crystal phase is fixed and the intended light-reflective layer is thereby formed. A most typical and preferred embodiment of the “fixed” liquid-crystal state is such that the alignment of the liquid-crystal compound to form the cholesteric liquid-crystal phase is held as such, to which, however, the invention is not limited. Concretely, the fixed state means that, in a temperature range of generally from 0 to 50 degrees Celsius, or from −30 to 70 degrees Celsius under a severer condition, the layer does not have flowability and does not undergo any alignment morphology change in an external field or by an external force applied thereto, and the layer can continue to stably keep the fixed alignment morphology. In the invention, the alignment state of the cholesteric liquid-crystal phase is fixed through the curing reaction as promoted by ultraviolet irradiation.

In the invention, it is enough that the optical properties of the cholesteric liquid-crystal phase are held in the layer, and finally it is any more unnecessary that the liquid-crystal composition in the light-reflective layer exhibits liquid crystallinity. For example, the liquid-crystal composition may be converted to a high-molecular weight substance and may lose the liquid crystallinity.

### 4. Use of Infrared-Light Reflective Plate

The infrared-light reflective plate of the invention exhibits a selective reflectivity characteristic with a reflection peak of 700 nm or longer (or more preferably from 800 to 1300 nm). The reflector having such a specific characteristic may be stuck on the windows of building structures such as houses, office buildings, etc., or to the windows of vehicles such as automobiles, etc., as a sunlight-shielding member. In addition, the infrared-light reflective plate of the invention may be used directly as a sunlight-shielding member by itself (for example, as heat-shielding glass, heat-shielding film).

The infrared-light reflective plate of the invention may achieve the maximum reflective ratio of 90% or higher for sunlight of from 800 to 1300 nm, and the maximum reflective ratio of 100% is most preferable. And especially, one feature of the infrared-light reflective plate of the invention resides in showing a high reflective ratio for the light of about 900 nm to about 1300 nm much contributing to the temperature-raise inside of any building or any vehicle, or that is, it is excellent in heat-shielding ability.

Other important properties of the infrared-light reflective plate are visible light transmittance and haze. By suitably selecting the material and suitably controlling the production condition and others and depending on the intended end-usage thereof, the invention can provide an infrared-light reflective plate having a preferred visible light transmittance and a preferred haze. For example, in an embodiment for use that requires a high visible transmittance, the invention can provide an infrared-light reflective plate having a visible light transmittance of at least 90% and having an infrared reflectivity that satisfies the above described sope.

### Second Invention

The second invention contributes to improvement in the light resistance of a laminated glass having a cholesteric liquid crystal layer inside. According to the second invention, the term “cholesteric liquid crystal layer” means not only any layer formed by curing any liquid crystal phase but also any layer capable of forming at least a cholesteric liquid crystal phase and transferring to another liquid crystal phase depending on temperature variation.

The second invention will be described in detail hereinafter.

The second invention relates to a laminate comprising, at least, a substrate, on a surface and/or a rear surface thereof, one or two or more cholesteric liquid crystal layers, and an easy-adhesion layer comprising a polyvinyl butyral resin as at least one outermost layer. Usually, a laminated glass is prepared by thermal compression bonding of an interlayer which is formed on the inner surfaces of two glass plates. When the laminate having one or plural cholesteric liquid crystal layer is incorporated into the two glass plates, the surface of the cholesteric liquid crystal layer is subjected to thermal compression bonding to the interlayer. However, the adhesive ability between them is insufficient, and air bubbles are generated between them when being subjected to an irradiation of natural light for a long time and being heated, which result in lowering the transparency. The laminate of the invention has an easy-adhesion layer as an outermost layer, and the surface of the easy-adhesion layer can be subjected to thermal compression bonding to the interlayer. Therefore, the adhesive ability is improved, which result in improving the light-resistance.

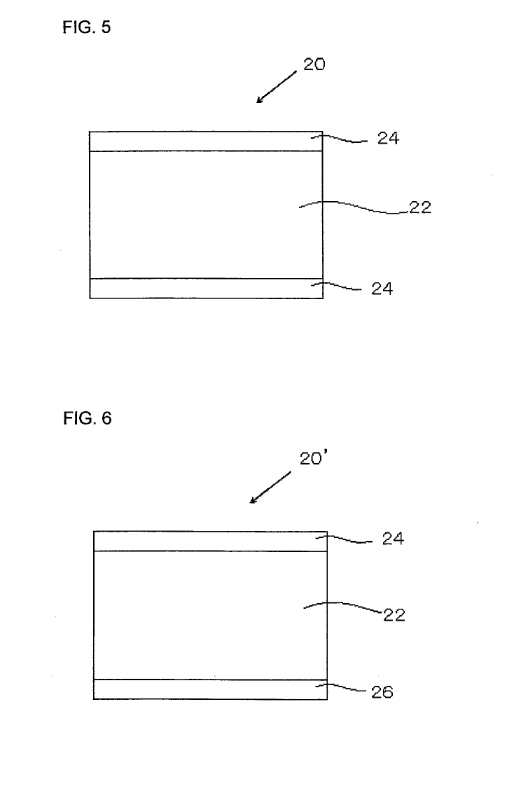

The laminate of the invention may have an easy-adhesion layer, as an outermost layer, disposed on both of a surface and a rear surface thereof; or the laminate of the invention may have an easy-adhesion layer, as an outermost layer, disposed on a surface thereof, and have an undercoat layer on a rear-surface thereof. FIG. 5 shows a cross-sectional frame format of an example of the former embodiment; and FIG. 6 shows a cross-sectional frame format of an example of the latter embodiment. The laminate 20 shown in FIG. 5 comprises a member 22, which has one or plural cholesteric liquid crystal layers, and an easy-adhesion layer 24, as an outermost layer, on both of the surface and rear-surface of member 22; and the laminate 21′ shown in FIG. 6 comprises a member 22, which has one or plural cholesteric liquid crystal layers, an easy-adhesion layer 24 as an outermost layer of the surface, and an undercoat layer 26 as an outermost layer of the rear-surface.

In the embodiment wherein the member 22 has one or plural cholesteric liquid crystal layers on only one surface as well as the infrared-light reflective plate shown in FIG. 1, preferably, the easy-adhesion layer 24 is formed on the surface of the uppermost layer (for example, in FIG. 1, the light reflective layer 16b), and the easy-adhesion layer 24 or an undercoat layer 26 is formed on the rear-surface of the substrate (for example, in FIG. 1, the substrate 12). In the embodiment wherein the member 22 has one or plural cholesteric liquid crystal layers on both of the surface and rear-surface as well as the infrared-light reflective plate shown in FIG. 2, preferably, the easy-adhesion layer 24 is formed on the surface of the uppermost layer (for example, in FIG. 2, the light reflective layer 16b), and the easy-adhesion layer 24 is formed on the lowermost layer (for example, in FIG. 2, the light reflective layer 18b).

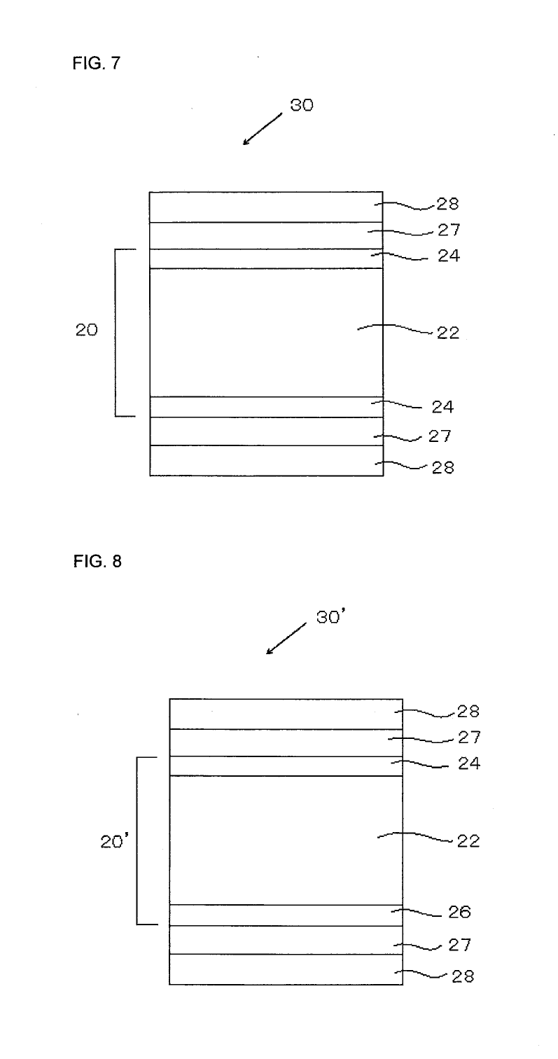

FIG. 7 and FIG. 8 show the cross-sectional frame formats of the laminated glasses having the laminates inside shown in FIG. 5 and FIG. 6 respectively. The laminated glass 30 shown in FIG. 7 may be prepared by thermal compression bonding of the easy-adhesion layers 24, which are formed on the surface and rear-surface of the laminate 20 shown in FIG. 5, and the interlayers 27 which are formed on the inner surfaces of the upper and lower glass plates 28 respectively. The laminated glass 30′ shown in FIG. 8 may be prepared by thermal compression bonding of the easy-adhesion layer 24 of the laminate 20′ shown in FIG. 6 and the interlayer 27 which is formed on the inner surface of the glass plate 28, and by thermal compression bonding of the undercoat layer 26 of the laminate 20′ and the interlayer 27 which is formed on the inner surface of the glass plate 28.

The laminated glasses 30 and 30′ shown in FIG. 7 and FIG. 8 may show any function attributed to the laminate 20 and 20′ which are incorporated thereinto, respectively. For example, the light reflective laminated glass capable of reflecting the light of which wavelength falls within the predetermined range is obtained by selecting the laminate (like as that shown in FIG. 1 or FIG. 2) having a cholesteric liquid crystal layer as a light reflective layer.

The laminated glass 30 or 30′, shown in FIG. 7 or 8, may be disposed so as to direct the surface of one glass plate 28 to the outside and the surface of another glass plate 28 to the inside. Some of the cholesteric liquid crystal layers may be degraded or discolored yellowish by irradiation of ultraviolet light. If the easy-adhesion layer 24 has ultraviolet absorptivity, it is possible to prevent the cholesteric liquid crystal layer from yellowish coloration and to further improve the light resistance, which is preferable. For example, if the laminated glass 30 or 30, shown in FIG. 7 or 8, is disposed so as to direct the upper glass plate 28 at the outside, the easy-adhesion layer 24 (in FIG. 7, the upper easy-adhesion layer 24) preferably contains any ultraviolet absorber for obtaining the ultraviolet absorptivity. If the combination of the easy-adhesion layer and the interlayer shows the ability of lowering the transmittance of the ultraviolet light of 380 nm or shorter to 0.1% or smaller, the yellowish coloration caused by an irradiation of the ultraviolet light may be reduced remarkably.

Next, the various material or methods to be used for preparing the laminate and the laminated glass of the second invention will be described in details.

### 1. Easy-Adhesion Layer

The laminate of the second present invention has at least one easy-adhesion layer containing polyvinyl butyral resin as a most-outer layer. Polyvinyl butyral is a type of polymer, having a repeating unit shown below, which can be obtained by reacting polyvinyl alcohol with butylaldehyde in a presence of acid catalyst.

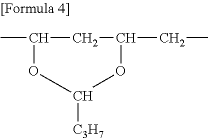

The easy-adhesion layer is preferably prepared by coating. For example, the easy-adhesion layer may be formed on the surface of the cholesteric liquid crystal layer by coating. More specifically, the light-reflective layer may be prepared as follows. A coating liquid is prepared by dissolving at least one polyvinyl butyral in an organic solvent, and is applied to the surface of the cholesteric liquid crystal layer, is dried, if necessary, under heat to form an easy-adhesion layer. Examples of the solvent to be used for preparing the coating liquid include methoxy propyl acetate (PGMEA), methylethyl ketone (MEK) and isopropanol (IPA). Any known coating methods may be used. The preferable range of the temperature for drying may vary depending on the types of the materials used for preparing the coating liquid, and, generally, is from about 140 degrees Celsius to about 160 degrees Celsius. The period for drying is not limited, and, generally, is from about five minutes to ten minutes.

It is preferable that the ultraviolet absorber is added to the easy-adhesion layer. It is especially preferable that the ultraviolet absorber is added to the easy-adhesion layer disposed between the cholesteric liquid crystal phase and the glass plate which is directed to the outside. Examples of the ultraviolet absorber which can be used in the invention include organic ultraviolet absorbers such as benzotriazole series, benzodithiol series, coumarin series, benzophenone series, salicylate ester series, and cyano acrylate series ultraviolet absorbers; and titanium oxide and zinc oxide. Especially preferable examples of the ultraviolet absorber include “Tinuvin326”, “Tinuvin 328” and “Tinuvin479” (all of which are commercially available from Ciba-Geigy Japan Ltd.). The kind and an amount of the ultraviolet absorber may be decided depending on the purpose. If the easy-adhesion layer, containing the ultraviolet absorber, can make the transmittance for the ultraviolet light with a wavelength of 380 nm or shorter equal to or smaller than 0.1%, the yellowish coloration caused by the ultraviolet light can be significantly reduced, which is preferable. Therefore, it is preferable that the kind and an amount of the ultraviolet absorber are decided so as to achieve the properties.

### 2. Undercoat Layer

The laminate of the second invention may have an undercoat layer for improving the adhesive ability to the interlayer which is formed on the inner surface of the glass plate. The undercoat layer may be a layer formed of acrylic resins, urethane resins, polyester resins or the like.

For example, if the laminate having one or plural cholesteric liquid crystal layers formed on only one surface of a polymer film such as a PET film is incorporated into a laminated glass, the rear-surface of the polymer film may be subjected to thermal compression bonding to the interlayer formed on the inner surface of the glass plate. In such a case, the adhesive ability may become insufficient when the polymer film formed of some kind of the material is used, and it is possible to improve the adhesive ability by forming an undercoat layer. Usually, the undercoat layer may be formed by coating. There are provided commercially available polymer films having an undercoat layer thereon, and such films may be used as a substrate.

The thickness of the undercoat layer is not limited, and, in usual, the thickness is preferably from about 0.1 to about 2.0 micro meters.

### 3. Laminated Glass

The two glass plates to be used for preparing the laminated glass may be selected from conventional glass plate, having an interlayer on the inner surface, for laminated glasses. Generally, the interlayer contains polyvinyl butyral (PVB) resin or ethylene-vinyl acetate copolymer (EVA) as a main ingredient. The easy-adhesion layer may have a good adhesive ability to the interlayer containing any material selected therefrom as a main ingredient. The easy-adhesion layer is especially excellent in the high adhesive ability in thermal compressive bonding to the interlayer containing polyvinyl butyral resin as a main ingredient.

The thickness of the glass plate is not limited, and the preferable range of the thickness may vary depending on the applications thereof. For examples, in the applications of a front window (windshield) for transport vehicles, generally, the glass plates having the thickness of from 2.0 to 2.3 mm are preferably used However, the thickness of the glass plate is not limited to the range. The thickness of the interlayer is, usually, from 380 to 760 micro meters.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### 1. Examples of First Invention

Coating Liquids (A), (B), (C) and (D) having the following formulation shown in the table were prepared respectively.

TABLE 1
Formulation of Coating Liquid (A)

| Materials (types) | Name (producer) | Amount | |
|---|---|---|---|
| Rod-like liquid | RM-257 (Merck) | 10.000 | parts by mass |
| crystal compound | | | |
| Chiral agent | LC-756 (BASF) | 0.293 | parts by mass |
| Polymerization | Irg-819 (Ciba | 0.419 | parts by mass |
| initiator | Specialty Chemicals) | | |
| Alignment | Compound 1 shown | 0.016 | parts by mass |
| controlling agent | below | | |
| Solvent | 2-butanone (Wako) | 15.652 | parts by mass |

TABLE 2
Formulation of Coating Liquid (B)

| Materials (types) | Name (producer) | Amount | |
|---|---|---|---|
| Rod-like liquid | RM-257 (Merck) | 10.000 | parts by mass |
| crystal compound | | | |
| Chiral agent | Compound 2 shown | 0.183 | parts by mass |
| | below | | |
| Polymerization | Irg-819 (Ciba | 0.419 | parts by mass |
| initiator | Specialty Chemicals) | | |
| Alignment | Compound 1 shown | 0.016 | parts by mass |
| controlling agent | below | | |
| Solvent | 2-butanone (Wako) | 15.652 | parts by mass |

TABLE 3
Formulation of Coating Liquid (C)

| Materials (types) | Name (producer) | Amount | |
|---|---|---|---|
| Rod-like liquid | RM-257 (Merck) | 10.000 | parts by mass |
| crystal compound | | | |
| Chiral agent | LC-756 (BASF) | 0.244 | parts by mass |
| Polymerization | Irg-819 (Ciba | 0.419 | parts by mass |
| initiator | Specialty Chemicals) | | |
| Alignment | Compound 1 shown | 0.016 | parts by mass |
| controlling agent | below | | |
| Solvent | 2-butanone (Wako) | 15.652 | parts by mass |

TABLE 4
Formulation of Coating Liquid (D)

| Materials (types) | Name (producer) | Amount | |
|---|---|---|---|
| Rod-like liquid | RM-257 (Merck) | 10.000 | parts by mass |
| crystal compound | | | |
| Chiral agent | Compound 2 shown | 0.153 | parts by mass |
| | below | | |
| Polymerization | Irg-819 (Ciba | 0.419 | parts by mass |
| initiator | Specialty Chemicals) | | |
| Alignment | Compound 1 shown | 0.016 | parts by mass |
| controlling agent | below | | |
| Solvent | 2-butanone (Wako) | 15.652 | parts by mass |

### [Formula 5]

Alignment controlling agent: Compound 1 (described in JP-A 2005-99248)

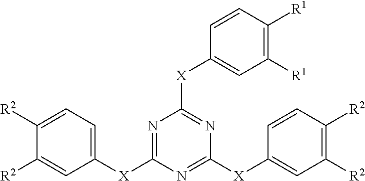

| R¹ | R² | X |
|---|---|---|
| O(CH₂)₂O(CH₂)₂(CF₂)₆F | O(CH₂)₂O(CH₂)₂(CF₂)₆F | NH |

### [Formula 6]

Chiral Agent: Compound 2 (described in JP-A 2002-179668)

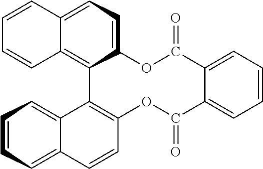

(1) Using a wire bar, each coating liquid was applied onto the PET film (manufactured by FUJIFILM) so as to have a dry thickness of 6 micro meters, at room temperature.

(2) This was dried at room temperature for 30 seconds to remove the solvent, and then heated in an atmosphere at 125 degrees Celsius for 2 minutes and thereafter at 95 degrees Celsius to form a cholesteric liquid-crystal phase. Next, using Fusion UV Systems' electrodeless lamp “D Bulb” (90 mW/cm), this was UV-irradiated at a power of 60% for 6 to 12 seconds, whereby the cholesteric liquid-crystal phase was fixed to form a film (light-reflective layer).

(3) After this was cooled to room temperature, the above steps (1) and (2) were repeated.

According to the above-described process, the infrared-light reflective plates shown in the following tables were produced respectively.

Regarding each of the produced reflective plates, the shielding ability of reflecting the solar spectrum of from 900 to 1300 nm was measured by using a spectrophotometer.

The heat-shielding capability was evaluated as follows: the reflectance of 75% or more for 900 to 1300 nm was evaluated excellent (◯), the reflectance of less than 75% and 70% or more was evaluated good (Δ), and the reflectance of less than 70% was evaluated inferior (X).

TABLE 5

| | | | | | | Reflectance |
|---|---|---|---|---|---|---|
| | | | | | | for |
| | | | | | | 900-1300 nm |
| | | | | | | (Heat- |
| | Sub- | | | | | shielding |
| | strate | Light reflective layer X1 | Light reflective layer X2 | Light reflective layer X3 | Light reflective layer X4 | capability) |
| Example 1 | PET | Coating Liquid (A) | Coating Liquid (B) | Coating Liquid (C) | Coating Liquid (D) | 80% |
| | Film | Right-Circularly Polarized | Left-Circularly Polarized | Right-Circularly Polarized | Left-Circularly Polarized | (∘) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1000 nm | Reflectivity: 1000 nm | Reflectivity: 1200 nm | Reflectivity: 1200 nm | |
| | | Orientation Order: 88° | Orientation Order: 85° | Orientation Order: 82° | Orientation Order: 78° | |
| Example 2 | PET | Coating Liquid (B) | Coating Liquid (A) | Coating Liquid (D) | Coating Liquid (C) | 76% |
| | Film | Left-Circularly Polarized | Right-Circularly Polarized | Left Circularly Polarized | Right-Circularly Polarized | (∘) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1000 nm | Reflectivity: 1000 nm | Reflectivity: 1200 nm | Reflectivity: 1200 nm | |
| | | Orientation Order: 88° | Orientation Order: 85° | Orientation order: 82° | Orientation Order: 78° | |
| Comparative | PET | Coating Liquid (A) | Coating Liquid (C) | Coating Liquid (B) | Coating Liquid (D) | 70% |
| Example 1 | Film | Right-Circularly Polarized | Right-Circularly Polarized | Left-Circularly Polarized | Left-Circularly Polarized | (Δ) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1000 nm | Reflectivity: 1200 nm | Reflectivity: 1000 nm | Reflectivity: 1200 nm | |
| | | Orientation Order: 88° | Orientation Order: 85° | Orientation Order: 82° | Orientation Order: 78° | |
| Comparative | PET | Coating Liquid (C) | Coating Liquid (D) | Coating Liquid (A) | Coating Liquid (B) | 65% |
| Example 2 | Film | Right-Circularly Polarized | Left-Circularly Polarized | Right-Circularly Polarized | Left-Circularly Polarized | (x) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1200 nm | Reflectivity: 1200 nm | Reflectivity: 1000 nm | Reflectivity: 1000 nm | |
| | | Orientation Order: 88° | Axial angle: 85° | Orientation Order: 82° | Orientation Order: 78° | |

In the process for preparing Example 1, the helical axial angle (the orientation order) was adjusted by adjusting the film-plane temperature during the step (2) to the temperature falling within the range of from 25 to 100 degrees Celsius and by adjusting the period for maturing the alignment; and in this way, an infrared-light reflective plate shown below (Referential Example 1) was produced.

According to the methods described above, the reflectance and the shielding capability were measured respectively. The evaluation result of the infrared-light reflective plate of Referential Example 1 was shown in the following table as well as the result of the infrared-light reflective plate of Example 1.

TABLE 6

| | | | | | | Reflectance |
|---|---|---|---|---|---|---|
| | | | | | | for |
| | | | | | | 900-1300 nm |
| | | | | | | (Heat- |
| | | | | | | shielding |
| | Substrate | Light reflective layer X1 | Light reflective layer X2 | Light reflective layer X3 | Light reflective layer X4 | capability) |
| Example 1 | PET | Coating Liquid (A) | Coating Liquid (B) | Coating Liquid (C) | Coating Liquid (D) | 80% |
| | Film | Right-Circularly Polarized | Left-Circularly Polarized | Right-Circularly Polarized | Left-Circularly Polarized | (∘) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1000 nm | Reflectivity: 1000 nm | Reflectivity: 1200 nm | Reflectivity: 1200 nm | |
| | | Orientation Order: 88° | Orientation Order: 85° | Orientation Order: 82° | Orientation Order: 78° | |
| Referential | PET | Coating Liquid (A) | Coating Liquid (B) | Coating Liquid (C) | Coating Liquid (D) | 70% |
| Example 1 | Film | Right-Circularly Polarized | Left-Circularly Polarized | Right-Circularly Polarized | Left-Circularly Polarized | (Δ) |
| | | Light Reflectivity | Light Reflectivity | Light Reflectivity | Light Reflectivity | |
| | | Thickness: 6 μm | Thickness: 6 μm | Thickness: 6 μm | Thickness: 6 μm | |
| | | Center Wavelength of | Center Wavelength of | Center Wavelength of | Center Wavelength of | |
| | | Reflectivity: 1000 nm | Reflectivity: 1000 nm | Reflectivity: 1200 nm | Reflectivity: 1200 nm | |
| | | Orientation Order: 78° | Orientation Order: 82° | Orientation Order: 85° | Orientation Order: 88° | |

As shown in the table above, as well as in Example 1, in Referential Example 1, the light reflective layers X1 and X2 having a reflection center wavelength of 1000 nm were disposed closer to the substrate. However, since the orientation orders of X1 and X2 were smaller than those of the light reflective layers X3 and X4 respectively, the reflectance was lowered to 70% and the heat-shielding capability of Referential Example 1 was inferior compared with Example 1.

### 2. Examples of Second Invention

### (1) Example 11

As a substrate, polyethylene terephthalate film (occasionally, referred to as “PET film”) having a thickness of 188 micro meters was prepared. The PET film, “FPA14-188” manufactured by FUJIFILM, had, on the surface and the rear-surface thereof respectively, an undercoat layer formed of urethane resin and an undercoat layer formed of acrylic resin.

Coating liquid (A) used in the above-described examples was applied to a surface of the substrate, dried, and then cured to form a cholesteric liquid crystal layer.

Next, Coating Liquid 1 having the following formulation was prepared. The coating liquid was applied to the surface of the cholesteric liquid crystal layer by using a bar so that the thickness of the dried layer was 2 micro meters, and then dried at 150 degrees Celsius for 7 minutes, thereby to form an easy-adhesion layer. In this way, Laminate 11 having the easy-adhesion layer was obtained.

Coating Liquid 1 for Easy-Adhesion Layer

| | |
|---|---|
| Methoxy propyl acetate (PGMEA) | 100 parts by mass |
| Polyvinyl butyral resin (“B1776” | 10 parts by mass |
| manufactured by ChangChun Group, Taiwan) | |

Next, two glass plates formed of clear glass (manufactured by Nippon Sheet Glass Co., Ltd.), having a PVB interlayer (15 mils (1 mil= 1/1000 inches=0.0254 mm)) on the surface thereof, were prepared, and disposed so as to direct the interlayers thereof to each other. Between them, Laminate 11 was disposed and was subjected to thermal treatment to adhere to them. In this way, a laminated glass was produced.

### (2) Example 12

Coating Liquid 2 having the following formulation was prepaed.

Coating Liquid 2 for Easy-Adhesion Layer

| | |
|---|---|
| Methoxy propyl acetate (PGMEA) | 100 parts by mass |
| Ultraviolet absorber (Tinuvin 326 (by Ciba Japan)) | 2.5 parts by mass |
| HALS Tinuvin 152 (by Ciba Japan) | 2.5 parts by mass |
| Polyvinyl butyral resin (“B1776” | 10 parts by mass |
| manufactured by ChangChun Group, Taiwan) | |

Laminate 12 was prepared in the same manner as Example 11, except that Coating Liquid 2 was used in place of Coating Liquid 1. Furthermore, a laminated glass was prepared in the same manner as Example 11, except that Laminate 12 was used in place of Laminate 11.

### (3) Comparative Example 11

A laminated glass was prepared in the same manner as Example 11, except that any easy-adhesion layer was not formed.

### (4) Comparative Example 12

Two glass plates formed of clear glass (manufactured by Nippon Sheet Glass Co., Ltd.), having a PVB interlayer (15 mils) on the surface thereof, were prepared, disposed so as to direct the interlayers thereof to each other, and not disposed any layer between them. In this way, a laminated glass was prepared.

### (5) Evaluation of Light Resistance

Regarding each of the laminated glasses prepared above, the light-resistance test was carried out under the following condition, and the evaluation was conducted in terms of the degree of the yellowish coloration and in terms of the presence or absence of air bubbles.

Conditions of Light Resistance Test

Apparatus: Iwasaki Electric Eye-Super UV (metal halide).

BP temperature: 63 degrees Celsius.

Irradiated side: Easy-adhesion layer side or Cholesteric liquid-crystal layer side.

Irradiation time: After the irradiation for 200 hours, the evaluation was conducted.

TABLE 7

| | Results of Light Resistance Test | |
|---|---|---|
| | Presence or Absence of | Yellowish |
| | Air Bubbles | Coloration (Δ YI) |
| Example 11 | Absence | 20.4 |
| Example 12 | Absence | 5.9 |
| Comparative Example 11 | Presence | 21.4 |
| Comparative Example 12 | Presence | 5.7 |

### DESCRIPTION OF REFERENCE NUMERALS

10, 10′ Infrared-light reflective plate (Infrared-light reflective plate of First Invention)
12 Substrate
14a Light-Reflective Layer (light-reflective layer X1)
14b Light-Reflective Layer (light-reflective layer X2)
16a Light-Reflective Layer (light-reflective layer X3)
16b Light-Reflective Layer (light-reflective layer X4)
18a Light-Reflective Layer
18b Light-Reflective Layer
20,20′ Laminate (Laminate of Second Invention)
22, 22′ Member having cholesteric liquid crystal layers
24 Easy-Adhesion Layer
26 Undercoat layer
27 Interlayer Film
28 Glass Plate
30,30′ Laminated Glass

1. An infrared-light reflective plate reflecting an infrared-light of equal to or longer than 700 nm comprising
a substrate, and, on at least one of surfaces of the substrate,
at least four light-reflective layers, X1, X2, X3 and X4, formed of a fixed cholesteric liquid crystal phase, and disposed in this order from the substrate,
wherein the reflection center wavelengths of the light-reflective layers X1 and X2 are same with each other and are λ₁ (nm), and the two layers reflect circularly-polarized light in opposite directions;
the reflection center wavelengths of the light-reflective layers X3 and X4 are same with each other and are λ₂ (nm), and the two layers reflect circularly-polarized light in opposite directions; and
λ₁<λ₂ is satisfied.

2. The infrared-light reflective plate of claim 1, wherein
the reflection center wavelength λ₁ (nm) of the light-reflective layers X1 and X2 falls within a range of from 800 to 1150 nm, and
the reflection center wavelength λ₂ (nm) of the light-reflective layers X3 and X4 falls within a range of from 1000 to 1400 nm.

3. The infrared-light reflective plate of claim 1, wherein
the light reflective layer X1 and the light reflective layer X3 reflect circularly-polarized light in a same direction; and
an orientation order of the light reflective layer X1 is higher than an orientation order of the light reflective layer X3.

4. The infrared-light reflective plate of claim 1, wherein
the light reflective layer X1 and the light reflective layer X3 reflect circularly-polarized light in a same direction, and an orientation order of the light reflective layer X1 is higher than an orientation order of the light reflective layer X3; and
the light reflective layer X2 and the light reflective layer X4 reflect circularly-polarized light in a same direction, and an orientation order of the light reflective layer X2 is higher than an orientation order of the light reflective layer X4.

5. The infrared-light reflective plate of claim 1, wherein
the light reflective layer X1 and the light reflective layer X3 comprise a right-rotation chiral agent; and
the light reflective layer X2 and the light reflective layer X4 comprise a left-rotation chiral agent.

6. The infrared-light reflective plate of claim 1, wherein
each of the light reflective layers X2, X3 and X4 is a layer which is formed by fixing a cholesteric liquid crystal phase of a liquid crystal composition applied to a surface of a lower light reflective layer.

7. The infrared-light reflective plate of claim 1, wherein the substrate is a polymer film.

8. The infrared-light reflective plate of claim 1, comprising an easy-adhesion layer as at least one outermost layer thereof.

9. The infrared-light reflective plate of claim 8, wherein the easy-adhesion layer comprises polyvinyl butyral resin.

10. The infrared-light reflective plate of claim 8, wherein the easy-adhesion layer comprises at least one ultraviolet absorber.

11. A laminated glass comprising:
two glass plates, and, between them,
an infrared-light reflective plate of claim 1.

12. A laminate comprising, at least,
a substrate, on a surface and/or a rear surface thereof,
one or two or more cholesteric liquid crystal layers, and
an easy-adhesion layer comprising a polyvinyl butyral resin as at least one outermost layer.

13. The laminate of claim 12, wherein
the easy-adhesion layer is a layer which is formed by applying a coating liquid comprising a polyvinyl butyral resin to a surface of the cholesteric liquid crystal layer.

14. The laminate of claim 12, comprising
the easy-adhesion layer as both of outermost layers.

15. The laminate of claim 12, comprising
the easy-adhesion layer as one of the outermost layers, and
an undercoat layer comprising one selected from an acrylic resin, an urethane resin and a polyester resin as another outermost layer.

16. The laminate of any claim 12, wherein the easy-adhesion layer comprises at least one ultraviolet absorber.

17. The laminate of claim 16, wherein the easy-adhesion layer is a layer which adjusts a transmittance value of an ultraviolet light having a wavelength of 380 nm or shorter to 0.1% or less.

18. A laminated glass comprising
two glass plates having an interlayer on an inner surface thereof respectively, and, between them, a reflective laminate of claim 12.

19. The laminated glass of claim 18, wherein the interlayer comprises a polyvinyl butyral resin or an ethylene-vinyl acetate copolymer.

20. The infrared-light reflective plate of claim 2, wherein
the light reflective layer X1 and the light reflective layer X3 reflect circularly-polarized light in a same direction; and
an orientation order of the light reflective layer X1 is higher than an orientation order of the light reflective layer X3.
